(19) United States
(12) Patent Application Publication
(10) Pub. No.: US 2016/0267509 A1
(43) Pub. Date: Sep. 15, 2016

(54) AUTOMATED RULES-BASED PRICING

(71) Applicant: Scientific Revenue, Inc., San Mateo, CA (US)

(72) Inventor: William Grosso, San Mateo, CA (US)

(21) Appl. No.: 15/026,019

(22) PCT Filed: Oct. 7, 2014
(86) PCT No.: PCT/US2014/059571

§ 371 Date: Mar. 30, 2016

Related U.S. Application Data
(60) Provisional application No. 61/887,932, filed on Oct. 7, 2013.
(60) Provisional application No. 61/888,514, filed on Oct. 9, 2013.
(60) Provisional application No. 61/887,923, filed on Oct. 7, 2013.

(51) Int. Cl. G06Q 30/02

(52) U.S. Cl. CPC G06Q 30/0206; G06Q 30/0283

(57) ABSTRACT

A system for automated rules-based pricing comprising a pricing engine that may generate payment structures and price values, a customer segmentation server that may analyze user behavior, and a pricing analysis server that proposes new price values based on analysis results, and a method for automated rules-based pricing.

### CROSS-REFERENCE TO RELATED APPLICATIONS

This application claims the benefit of, and priority to, U.S. provisional patent application Ser. No. 61/887,932, titled “RULES BASED PRICING ENGINE” and filed on Oct. 7, 2013, and also claim the benefit of, and priority to, U.S. provisional patent application Ser. No. 61/888,514, titled “PREDICTIVE MESSAGING” and filed on Oct. 7, 2013, and also claims the benefit of, and priority to, U.S. provisional patent application Ser. No. 61/887,923, titled “PRICING CONFIGURATION AND AUTOMATION” and filed on Oct. 7, 2013, the entire specifications of each of which are incorporated herein by reference in their entirety.

### BACKGROUND OF THE INVENTION

1. Field of the Art

The disclosure relates to the field of dynamic pricing, and more particularly to the field of configuring and automating pricing behavior.

2. Discussion of the State of the Art

The emergence of large-scale online gaming communities, and the more recent arrival of mobile gaming as a major market, have presented dramatic opportunities for merchants. Users of online and mobile games have shown a willingness to make in-app (or in-game) purchases, generally of virtual goods (e.g., points, game items, game capabilities, etc.), and provide vendors with a rich variety of behavior data. In such a data rich, behaviorally complex environment, pricing becomes a very complex art. In the art, few tools are available to facilitate pricing of in-app or in-game items, and most such pricing is done manually and in an ad hoc fashion. A great deal of “tribal knowledge” rules in this area, with thumbrules and ideas that may work in the physical commerce world of bricks-and-mortar retailers are assumed to be valid in the online and mobile gaming worlds (and similar areas, such as online gambling, online education, digital media, and the like).

What is clearly needed is a system that brings science to the world of pricing in online environments, and that enables highly automated, adaptive, dynamic and rules-based pricing of in-game, in-app, or equivalent items.

### SUMMARY OF THE INVENTION

Accordingly, the inventor has conceived and reduced to practice, in a preferred embodiment of the invention, a system and methods for rules-based pricing that updates pricing rules based on customer behavior and provides a message-based price updating capability.

According to a preferred embodiment of the invention, a system for dynamic psychologically-friendly pricing via a dynamic pricing system that produces price values based on customer behavior, in an online digital entertainment environment, comprising a pricing console computer comprising program code stored in a memory and adapted to operate an interface for receiving user interaction, a database computer comprising program code stored in a memory and adapted to store information from the other components of the system, a pricing engine computer comprising program code stored in a memory and adapted to generate at least a plurality of parameterized price values, a pricing analysis server computer comprising program code stored in a memory and adapted to analyze at least the price values and provide the analysis results to the pricing console, and a customer segmentation server computer comprising program code stored in a memory and adapted to receive customer interactions via a digital packet network and to generate customer behavior data values based at least in part on those interactions, and to provide the behavior data values to the pricing engine, is disclosed.

According to another preferred embodiment of the invention, a method for automated rules-based pricing, comprising the steps of generating, using a pricing engine computer comprising program code stored in a memory and adapted to generate at least a plurality of pricing rules, an initial set of pricing rules, monitoring, using a customer segmentation server computer comprising program code stored in a memory and adapted to receive customer interactions via a digital packet network and to generate customer behavior data values based at least in part on those interactions, and to provide the behavior data values to the pricing engine, customer behavior data, analyzing, using a pricing analysis server computer comprising program code stored in a memory and adapted to analyze at least the pricing rules and provide the analysis results to the pricing console, the behavior data, providing the analysis results to the pricing engine, and modifying the pricing rules based at least in part on the analysis results, is disclosed.

According to another preferred embodiment of the invention, a method for message-based automated pricing, comprising the steps of generating, using a pricing engine computer comprising program code stored in a memory and adapted to generate at least a plurality of pricing rules, an initial set of pricing rules, generating, using a pricing message client comprising program code stored in a memory and adapted to produce price message objects, and adapted to provide the price message objects to other components of the system via a digital packet network, a plurality of price message objects, providing the price message objects to the pricing engine via a digital packet network, and modifying the pricing rules based at least in part on the received price message objects, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a system architecture diagram illustrating an exemplary system for dynamic psychologically-friendly pricing, according to a preferred embodiment of the invention.

FIG. 6 is a method flow diagram illustrating an exemplary method for generating and modifying pricing rules, according to a preferred embodiment of the invention.

FIG. 7 is a method flow diagram illustrating an exemplary method for message-based pricing modification, according to a preferred embodiment of the invention.

FIG. 8 is an illustration of an exemplary user interface for viewing pricing rules.

FIG. 9 is an illustration of an exemplary user interface for modifying pricing rules.

FIG. 10 is an illustration of an exemplary user interface for modifying pricing rules.

FIG. 11 is an illustration of an exemplary user interface for viewing pricing reports.

### DETAILED DESCRIPTION

The inventor has conceived, and reduced to practice, in a preferred embodiment of the invention, a system and methods for rules-based pricing that updates pricing rules based on customer behavior and provides a message-based price updating capability.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

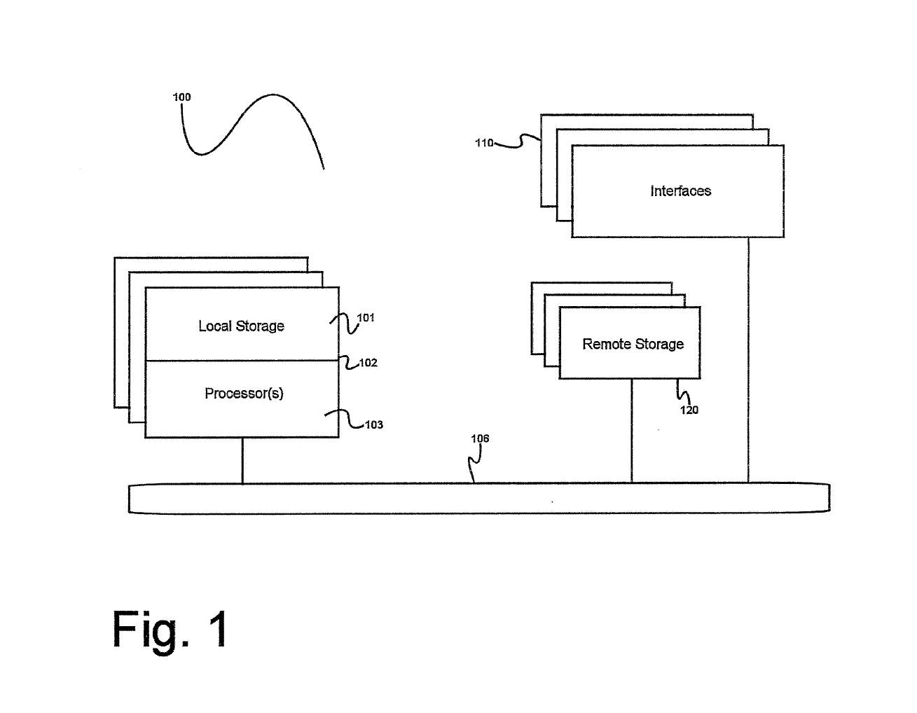

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

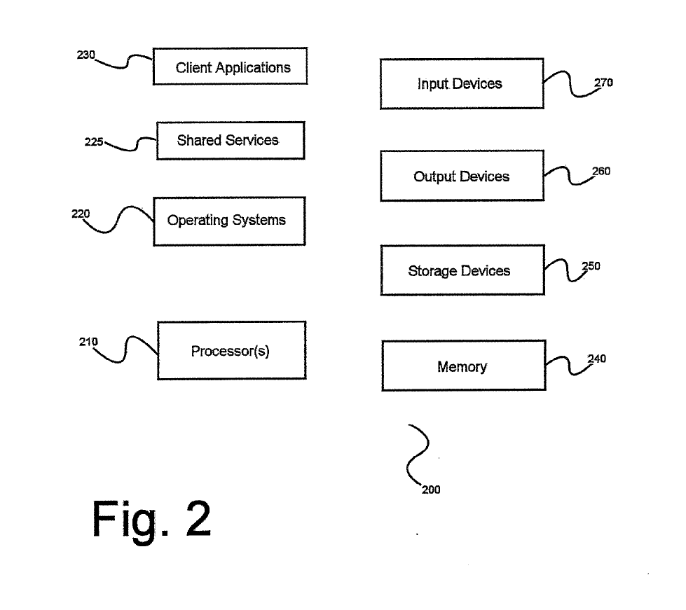

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

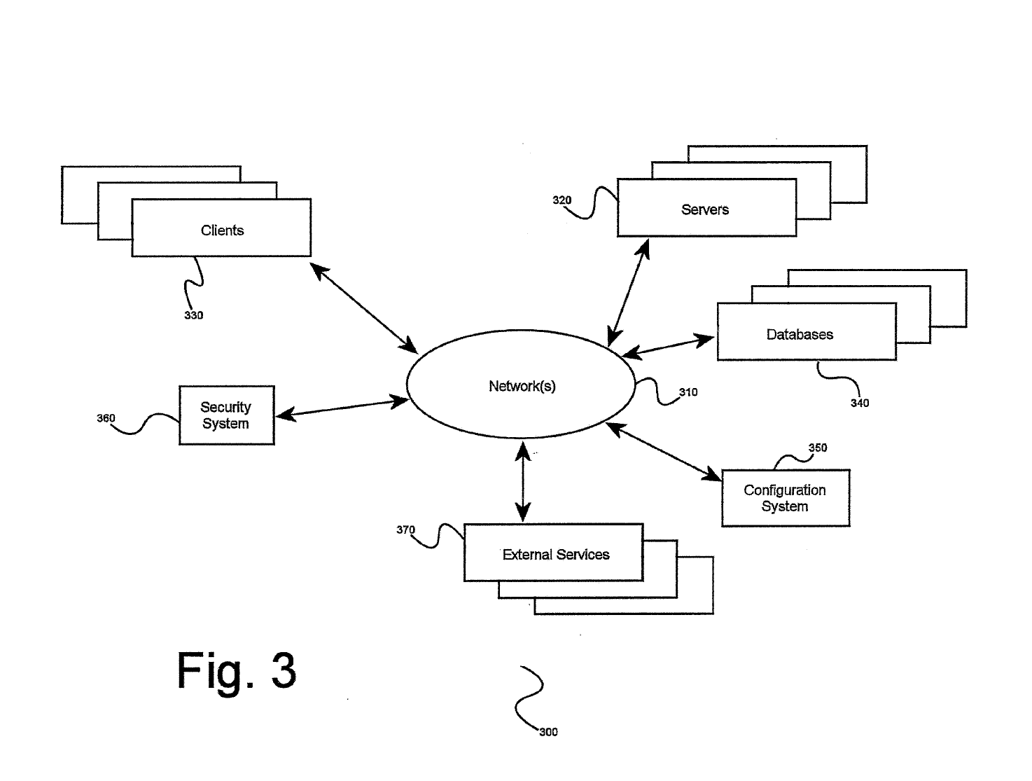

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

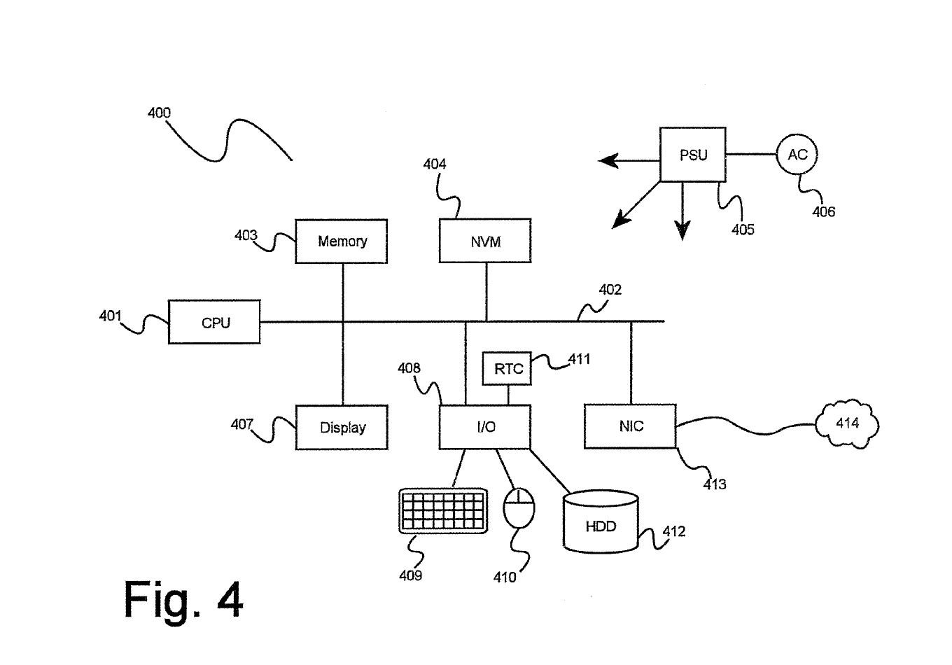

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

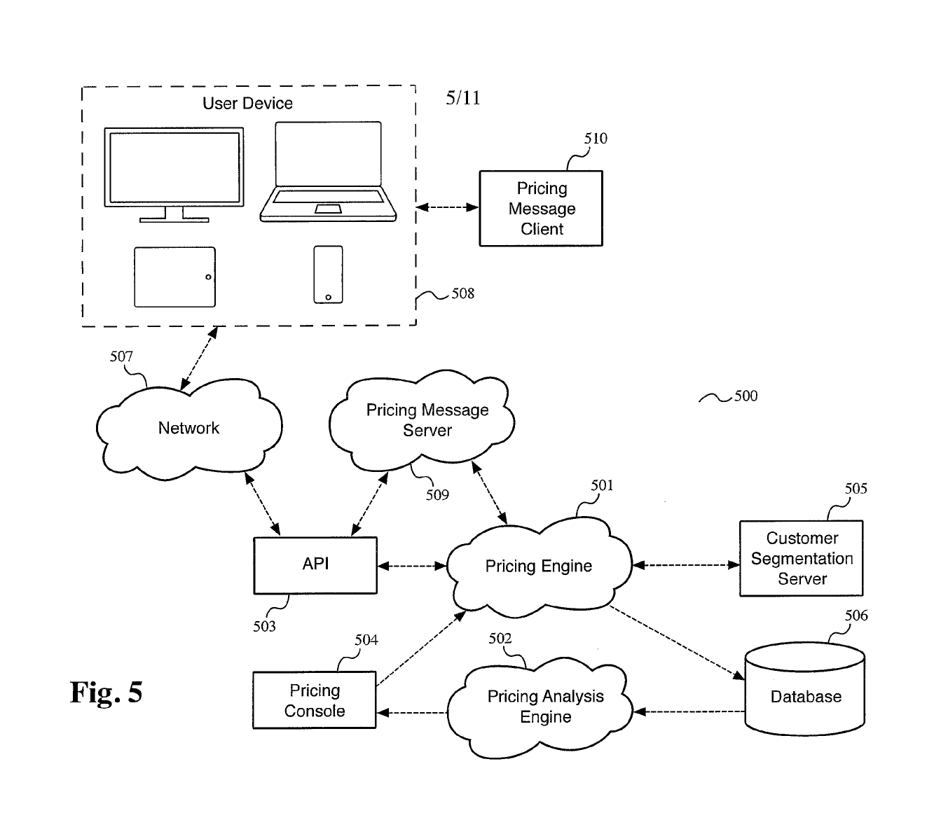

FIG. 5 is a system architecture diagram illustrating an exemplary system 500 for dynamic rules-based pricing, according to a preferred embodiment of the invention. According to the embodiment, a pricing engine 501 computer may be a computer comprising at least program code stored in a memory and adapted to generate a plurality of price values such as for use in payment systems for online entertainment (hereinafter referred to as “paywalls”), and may be connected such as via a digital packet network (such as the Internet or other suitable communication network) to other components of a system 500, such as a database 506 that may be a computer comprising at least program code stored in a memory and adapted to facilitate storage of information from a pricing engine 501 or other components of a system 500. System 500 may further comprise a software application programming interface (API) 503 that may comprise at least program code adapted to facilitate integration or communication with any of a variety of external or third-party products or services, such as including but not limited to software-based services such as social media networks or websites, or physical devices such as personal computers or smartphones, or any other such device that may operate program code and communicate via a network, and any variety or quantity of such external or third-party products or services may be utilized simultaneously or interchangeably according to the embodiment.

Further according to the embodiment, a customer segmentation server 505 may be a computer comprising at least program code stored in a memory and adapted to receive and interpret customer behavior data (such as may be provided by an API 503), for example to categorize, sort, or otherwise identify customers or other users based on observable behavior information. Customer segmentation server 505 may then provide customer segmentation information to a pricing engine 501 such as for use in producing price values, for example to determine appropriate values based on known customer behavior to increase likelihood of a purchase, or to offer promotions or bonuses based on certain behaviors or behavior patterns (for example, rewarding loyal customer with a high purchase history, or offering a temporary discount to someone who has been observed considering a purchase for some time, but has not committed).

Further according to the embodiment, a pricing analysis engine 502 may be a computer comprising at least program code stored in a memory and adapted to perform analysis of at least a plurality of price value data, such as may be provided by a pricing engine 501 or retrieved from a database 506. Such analysis may comprise, for example, determining the “psychological friendliness” of pricing values, or analysis of price values with regard to known customer or user behaviors or activities such as to determine the effectiveness of a pricing strategy or user or demographic-specific pricing optimizations. Additionally, a pricing console 504 may be a computer comprising at least program code stored in a memory and adapted to receive interaction from a human user, for example via a software-based interface that may optionally present data from components of a system 500 as well as accept input such as to facilitate interaction with, or control of, other components of a system 500. In this manner, a user may be able to review the operations of various components or activities within a system 500, as well as provide input to assist in configuring or directing operations, for example to enable a human review analyst to further optimize operation using information external to a system (such as new policies that may affect pricing, for example).

Further according to the embodiment, an API 503 may communicate with program code stored and operating on a user's electronic device 508 (such as a personal computer, tablet computing device, smartphone, or any other of a wide variety of suitable electronic devices that may be capable of storing or operating program code and communicating via a network) such as via a digital packet network 507 (such as the Internet or other suitable communication network), for example to receive “ambient data” such as hardware or usage information from the device 508. For example, it is common in the art for a number of hardware sensors to be present on an electronic device such as a smartphone, such as for example a magnetometer, accelerometer, or any of a variety of radio communication hardware such as cellular or Wi-Fi antennas or modules. Such hardware may be used to, for example, provide usage information such as network utilization or location information, or any other such hardware data that may be relevant to pricing operations.

Further according to the embodiment, a pricing message server 509 may be a computer comprising at least program code stored in a memory and adapted to produce or receive message data objects suitable for use by other components of a system 500, for example that may be readily interpreted into actions to be performed (for example, sending a message object to a pricing engine 501 causes the pricing engine 501 to take a specific action based on the nature or content of the message object). Pricing message server 509 may communicate with external products or services such as a user's device 508 via an API 503, and additionally a pricing message client 510 may be a computer comprising at least program code stored in a memory and adapted to produce message data objects suitable for use or interpretation by the messaging server 509, such that a user device 508 may send message objects to the message server 509 in order to trigger activity within a system 500 or otherwise interact with components of system 500. Additionally, message objects may be stored or queued in a “stack” or suitable orderly fashion, for example so that a device that has lost network connectivity may send messages when a connection is established, in the order they were generated so the sequence of operations is not lost.

Below are exemplary code samples and description of an exemplary pricing rule engine and software-based “wizards” that may be utilized according to the embodiment. It should be appreciated that the code samples and software descriptions given are exemplary and a variety of additional or alternate arrangements may be utilized according to the invention.

Cohorts can be related in a number of ways: a cohort can be a drilldown of another cohort (his happens when the user creates a new cohort that has all the conditions of the previous cohort, and adds another one); a cohort can be a broadening of another cohort. The is the opposite of a drilldown; a cohort can be a replacement of another cohort (may support the idea of replacing or refining a cohort definition); and a cohort can be superceded by another cohort. This is the opposing of being a replacement.

Large scale cohort actions that may be performed by a segmentation server may include: generate cohorts from business metadata (this is the “initial” generation of cohort definitions); and regenerate cohorts from business metadata (may make it possible for people to regenerate all the basic pricing rules, cohorts, etcetera). The large-scale sequence is: regenerate all the cohorts, creating new cohorts and marking them as replacements for the old cohorts; put creation data boundaries on the old cohorts (so, moving forward, no new users get the cohorts); do functionally equivalent things for monetary policies and basic pricing rules—everything is “edited” and nothing is live, and let the user make a big “go live/push edits live” decision separately; and retire cohorts that have old creation date boundaries.

This enables such functionality as regenerating with new data (note that older users may retain their old policies for a while), and then retire those old policies after a time (optionally predetermined or configurable according to a particular use case or arrangement).

In this manner, the invention aims to reduce complex payment wall analysis and operation to a more manageable level through the use of variable parameters, rules, schedules, and metrics. By reducing the complex nature of payment walls or other payment systems, it becomes possible to perform much more straightforward and easily understood operations and analysis through the use of discrete, granular components that may be combined to form the more complex rules and operations that govern the overall payment system's behaviors. A variety of exemplary components such as payment rules, schedules, user segments, and other parameters are discussed in detail below, and it should be appreciated that a wide variety of additional or alternate elements may be utilized according to the invention.

### Minor Actions

These are called “minor” because they may generally be invoked on a single cohort. Such actions may include: make live—this makes a single cohort that has not been live previously, live; push edit live—this pushes an edit to a cohort live; set user creation date boundaries—this is one way of killing a cohort, ideally without changing the definition (or minimizing any change); retire—the marks a cohort as dead (from this moment on, a cohort will not match any user); add a note—this is entirely an audit trail action; “clone and tweak”—this is the core creation operation, tweak is usually “drilldown and create reporting-only cohort”; edit filter and sort metadata—the metadata has no impact on production, so this is a freely available operation; set role—mark a cohort as “for reporting only” (or remove the mark), and ideally check that it's not being used in any pricing rules; separate (copies parent clauses in, and detaches. Until we separate, changes to the parent impact changes to the child because of the use of the CURRENTLY_IN_COHORT predicate); and “in place edit” (happens in editing pane of an admin interface).

In a preferred embodiment there may also be a general “retire cohorts” flow—over time the customers will accumulate cohort “cruft”. The clues that a cohort is eligible for retirement include: very few people in it (under 1%, for example); mostly identical to another cohort—there are two main cases here, “you've got two cohorts that have greater that 80% overlap” and “cohort A is a subset of Cohort B, has similar performance characteristics, and is more than half of it”; it contains more than half the active population; it isn't explicitly listed as a reporting cohort and yet there are no pricing rules referencing it; or all the pricing rules referencing it have been retired.

In all of these cases, we need to figure out what rules reference the cohort. But . . . the key idea is that pruning the cohort set is going to be important over time (if we don't provide tools to manage the cohorting, we'll either wind up computing an infinite number of cohorts OR the end users will wind up frustrated).

What Happens when a Cohort is Changed or Created

When creating (or editing) a cohort, an E-commerce manager may create a brand new cohort, then want to create a pricing rule for that cohort; they may also want to view a report for that cohort. At some point they should expect: the cohort changes (or the new cohort) to be “live” in the transactional system—this should happen as soon as they push to live (e.g. within 30 seconds); the pricing rule changes to be “live” in the transactional system—this should happen as soon as they push to live (e.g. within 30 seconds); and the reporting on the cohort and pricing rule to be accurate. The realtime cohorting will gradually stabilize, but a requirement may be that the next day's reporting be accurate. The goal should be that within a reasonably short timeframe the cohorting servers have completely updated the cohort records for every user, and that the next time a report dump is created, the new cohorts are fully accurate. There are three primary actions for cohorting (and the first two may be considered to be the same action—“regenerate” should happen across cohorts, pricing rules, etcetera at the same time): generate pricing rules from business metadata; regenerate pricing rules from business metadata; and retire pricing rules that are not often used. There may also be an action for “global bump up/down”—these are ANDROID™ specific actions that raise and lower all baseline prices across the board. They are large scale actions. Technically speaking, these replace baseline monetary policies, but they are more naturally thought of as pricing rule changes.

Below are exemplary code samples that may illustrate the features and functions described.

### Initial Code

```
CHARGE_MORE = 1
CHARGE_LESS = 2
CHARGE_SAME = 3
POLICY_CHOICES = (
    (CHARGE_MORE, ‘Charge More’),
    (CHARGE_LESS, ‘Charge Less’),
    (CHARGE_SAME, ‘Charge the same’),
)
VARY_INITIAL_EXCHANGE_RATES = 1
VARY_DISCOUNTED_EXCHANGE_RATES = 2
VARY_CURRENCY_MULTIPLICATION_RATES = 3
VARY_SIZE_OF_INITIAL_PURCHASE = 4
PRICE_VARIATION_MODEL_CHOICES = (
    (VARY_INITIAL_EXCHANGE_RATES, ‘Vary changes in discount rates’),
    (VARY_DISCOUNTED_EXCHANGE_RATES, ‘Vary changes in discount rates’),
    (VARY_CURRENCY_MULTIPLICATION_RATES, ‘Vary how much currency is
sold ’),
    (VARY_SIZE_OF_INITIAL_PURCHASE, ‘Vary payment rungs (lowest RMT
price)’),
)
use_price_skimming = models.BooleanField(default=True)
boil_the_frog = models.BooleanField(default=True)
aggressively_try_to_convert_grinders = models.BooleanField(default=True)
aggressively_try_to_convert_at_risk_players = models.BooleanField(default=True)
offer_first_week_conversion_incentives = models.BooleanField(default=True)
offer_second_purchase_conversion_incentives = models.BooleanField(default=True)
price_engagement_policy =
models.IntegerField(choices=POLICY_CHOICES,default=CHARGE_SAME)
price_addiction_policy =
models.IntegerField(choices=POLICY_CHOICES,default=CHARGE_MORE)
gamer_policy = models.IntegerField(choices=POLICY_CHOICES,
default=CHARGE_MORE)
affluence_policy =
models.IntegerField(choices=POLICY_CHOICES,default=CHARGE_MORE)
preferred_price_variation_model
=models.IntegerField(choices=PRICE_VARIATION_MODEL_CHOICES,default=
VARY_SIZE_OF_INITIAL_PURCHASE)
```

### What the Fields Mean

The exemplary code fields above are described in greater detail below for clarity.

Fields that are only used to define base payment wall changes: gamer_policy—if the cohorting system spots that someone is a gamer (fico score model), in a first pass, alter choice of base payment wall for this player; affluence_policy—if the cohorting system spots that someone is affluent (fico score model), in a first pass, alter choice of base payment wall for this player (note that, globally, the affluence model uses device characteristics, paid applications, and bandwidth. Within the USA, it also leverages location). Note also that peripherals (BLUETOOTH™ devices) and service providers (such as preferring Verizon to T-Mobile in US markets) may matter.

Fields that are Used to Define Payment Walls and Trigger Bonus Price Adjustment

There may be two parameters here: price_engagement_policy—this handles the question of “should we charge highly engaged users more, or less, or ignore engagement for purposes of pricing”, and this parameter controls the base payment wall (both for charge more and charge less) and, for charge more, prevents low priority bonuses from being applied; and price_addiction_policy—this handles the question of “what to do if we spot addiction”. The options are much like those for price engagement. In particular, engagement is a very high level idea that decomposes nicely into attention, loyalty, and intensity. “Mindshare” may be thought of as generally “how many distinct time-slots per day”, or in another sense, “do people keep thinking about the game all day long?”, and may be used as an additional measure of engagement along with percentage of playing time. Other data that may be relevant for consideration may include “are other games resident in memory?”, or “given industry standard data about how many minutes per day people are playing, is the game consuming a disproportionate amount of time?”.

It is useful to change definitions and strategies because engagement and addiction are complex in terms of price theory: when a user starts playing a game, they have almost no investment in the game and there are other substitutes out there (other sources of entertainment value)—the game company is, in essence, in a position of being a competitive supplier of a generic good (“fun”); additionally, as the user transitions to a long-term user, and to a highly engaged user, their investment increases and the game company transitions to a position of being a monopoly supplier of a highly differentiated good (“gold bullion in my favorite game”).

Fields that are only used to trigger bonus price adjustment changes may include: aggressively_try_to_convert_grinders—a “grinder” is someone who exhibits two major characteristics, high engagement and no purchasing (they may be considered either a great word-of-mouth asset, typically early in a game's lifecycle, or a drain on the economy)—this flag triggers a set of rules that will look for high engagement low spend players and offer them inducements to spend; and aggressively_try_to_convert_at_risk_players (an at-risk player is one that may be very likely to churn)—“they're about to leave, might as well tap them once more before they exit”; or “If we can get them to do a big purchase, we might be able to keep them around (large wallet of coins as engagement device)”; offer_first_week_conversion_incentives (first week conversion incentives are incentives designed to convince a “new” player to make their first purchase); offer_second purchase_conversion_incentives (once a player has purchased, the question is “how do we make a one-time event into a habit”)—these rules are designed to do so, if it appears that they are unlikely to purchase again quickly on their own; use_price_skimming—price skimming is the practice of gradually increasing discounts to convince non-spenders to convert (it can be a dangerous practice—if there is a predictable schedule of discounts, and consumers catch on, there is a danger of “gaming” the system, a practice known as “intertemporal price discrimination”. On the other hand, in order to effectively game the system, the consumer has to be willing to play the game without coins while waiting for the discount, and to have the same utility function for coins-delivered-now and coins-delivered-in-the-future—which is not, by and large, the gaming use case; and boil_the_frog—this is the practice of gradually removing incentives from users (there are two dominant interpretations: either remove the incentives for all users, or just remove them for users who have monetized).

Fields that express preferences but don't directly impact a single user's prices may include a preferred_price_variation_model. This is the only exemplary parameter that isn't based in behavioral or economic theory. It attempts to address the question “how should we raise prices?” The four options are: VARY_INITIAL_EXCHANGE_RATES, ‘Vary changes in discount rates’; VARY_DISCOUNTED_EXCHANGE_RATES, ‘Vary changes in discount rates’; VARY_CURRENCY_MULTIPLICATION_RATES, ‘Vary how much currency is sold’; and VARY SIZE_OF_INITIAL_PURCHASE, ‘Vary payment rungs (lowest RMT price)’, each of which represent different ways to raise prices.

### Initial Rules for Base Payment Walls

Flags that correspond to important segments for differential pricing may include: gamer_policy—corresponds to membership in the segment “garners”; affluence_policy—corresponds to membership in the segment “affluence”; price_engagement_policy—corresponds to membership in one of “High Initial Engagement and Joined in Last Seven Days”, or “High Seven Day Engagement and Regulars”; and price_addiction_policy—corresponds to membership in the segment “addicts”.

### General Notes

The base payment wall rules are all built off the notion of a modified pricing score. That is, start with an exemplary pricing score of 3 (to allow room to move downstream) and for each “member in cohort and charge more”, add one. Then, for each “member in cohort and charge less”, subtract one. Finally, use the eventually indicated pricing score to pick out a base payment wall.

Note that “more specific” should match higher. That is, “3 cohorts” is higher priority than “2 cohorts” and that the priorities may for example be: zero matches—goes to default payment wall, no rule necessary; one match—priority is Low Priority Base Payment Wall (20); two matches—priority is 17; three matches—priority is 13; and four matches—priority is Low Priority Base Payment Wall (10) (gives plenty of room to insert higher priority rules below).

Note also that in an exemplary implementation, 27 base payment wall rules are generated if a user accepts the defaults (and 81 if they choose differential charging on all flags). This might indicate a need to separate rules in the UI, for example rules that set base payment walls, and sorting rules by priority.

### Initial Rules for Price Adjustments

Like the base payment wall rules, these rules are keyed off segment membership. They are, however, slightly more complex. They also divide into two categories: rules that grant bonuses to users; and rules that interdict (or prevent) users from getting bonuses.

An exemplary pricing rule may comprise a priority, max size, percentage assignment, a set of conditions that a user must meet, and a set of prices (aka monetary policies) for the user that result from meeting the conditions. A basic pricing rule has no max size or percentage assignment, says that the condition is cohort membership, and then asserts a monetary policy as a consequence. A multi-armed bandit has no max size, but a percentage assignment and possibly a cohort, and then outlines a set of basic pricing rules to follow (“pricing strategies” TBD but almost certainly a namespaced set of pricing rules). An A/B test has a size, a percentage and possibly a cohort, and outlines a set of pricing strategies to follow (same caveat on pricing strategies).

### Relationships Between Basic Pricing Rules

Rules may have relationships with one another. For example, two rules may have the same positive and negative cohort lists, or two rules may have the same positive and negative cohort lists, and one be a baseline monetary policy and one be an adjustment. Additionally, a set of rules may be explicitly asserted to be part of a “Rule Group”—this may be a defined tag that may then be used in filtering.

There are ideally 4 different types of rules: basic pricing rule for baseline; basic pricing rule for adjustment; multi-arm bandit rules; and A/B test pricing rule.

Some exemplary rules that grant bonuses may include (but are not limited to):

aggressively_try_to_convert_grinders. A “grinder” is a player who exhibits high engagement, but has not purchased. This rule offers the grinder additional inducements to purchase. Priority is “High Priority Price Adjustment (50)”, and membership conditions require at least one of the following: NOT (Joined in Last 7 days) and High 7 Day Engagement and Has Never Purchased; NOT (Joined in Last 14 days) and Regulars and NOT (Low 14 Day Engagement) and NOT (Purchased Within Last 14 Days); or NOT (Joined in Last 21 days) and Regulars and NOT (Low 21 Day Engagement) and NOT (Purchased Within Last 14 Days). An additional bonus condition (such as for determining if a special bonus or promotional offer should be applied) may be “Abandoned Payment Wall Within Last 3 Days”. Consequences: need the price advertisement to actually say “Hey, you got an extra bonus”—since it's a grinder, we're going us a price advertisement along the lines of “Loyal Player Bonus” (implicit requirement: generating the price advertisement); 10% bonus on slots 3 and higher; 15% additional bonus on slots 4 and higher; and 15% additional bonus on slots 5 and higher. A further additional bonus condition may be “10% more bonus on slots 3 and higher” (so 20% bonus).

aggressively_try_to_convert_at_risk players. Priority may be “Medium to High Priority Price Adjustment (60)”, and membership condition is “at risk”. Additional bonus conditions: “Abandoned Payment Wall Within Last 14 Days”; “Has Purchased”; “Dolphin”; “Whale”; and “Overdue to spend”. Consequences: need the price advertisement to actually say “Hey, you got an extra bonus”—this can use the same as a grinder, using a price advertisement along the lines of “Loyal Player Bonus” (implicit requirement: generating the price advertisement); 10% bonus on slots 3 and higher; 15% additional bonus on slots 4 and higher; 15% additional bonus on slots 5 and higher. Additional bonus condition: 10% more bonus on slots 3 and higher for each bonus condition.

Rules that Interdict

Interdiction rules are different—they basically stop discounts from being applied, so they inherently have multiple priorities (since they stop further stacking). Some exemplary interdiction rules are described below.

boil_the_frog. This works as follows: if BTF is set, require membership in “Purchased Within Last 14 Days” and count the number of memberships in the following segments: “Frequent Purchases”; “Whale”; “Purchased in Last Three Days”; “Current Low Wallet Balance”; and “Addicts”. Priority: (4 or more) Only Allow High Priority Price Adjustments: 55; (3 segments) Only Allow Medium to High and higher Priority Price Adjustments: 65; (2 segments) Only Allow Medium and higher Price Adjustments: 75; or (0 or 1 segments) Low to Medium and higher Priority Price Adjustments: 85. Consequences: Interdiction.

price_engagement_policy. Priority: Only Allow Medium to High and higher Priority Price Adjustments: 65. Membership Conditions: “NOT (Joined in Last 7 days) and Regulars and High 7 Day Engagement”. Consequences: Interdiction.

price_addiction_policy. Priority: Only Allow High Priority Price Adjustments: 55. Membership Conditions: “NOT (Joined in Last 7 days) and Addicts and High 7 Day Engagement”. Consequences: Interdiction.

### Wizard Based Rules

The above rules are, more or less, the readily-apparent rules, described for the sake of example and should not be considered to be limiting of the possible rules or variations that may be utilized according to the invention. There are a large number of other rules that apply in certain situations: should have a small number of rules at first, and gradually evolve things; managing complexity; giving pricing managers things to do; many rules only apply for certain games or in certain situations; and should capture low-hanging fruit.

### Why Use Wizards

Generally speaking, most of the incremental rules follow a similar structure. They generally involve some level of intellectual complexity and need an explanation, and they involve setting some parameters, or determining a priority level.

### General Structure of Wizards

A new rule button may support a set of different types of rules. Every rule wizard might typically probably start with an explanation (rules will be created infrequently, and it's worth explaining them in-place).

Below are a variety of exemplary price rules and price rule generation examples, including software means for user interaction and configuration of pricing rules via software-based “wizards”, or other such software applications adapted to enable a user to easily configure pricing rules according to the invention. It should be appreciated that the rules and means described are exemplary, and a variety of pricing rules, rule types, or software means may be utilized according to the invention.

Wizards and Special Rule Types

In addition to the above, it may be desirable to utilize “special rules”, for example under specific circumstances: create a happy hour; create a temporary sale; create a time-limited recurring sale; create a first purchase incentive; create a declining engagement incentive; create a pay-to-stay incentive; or create a pay-to-switch incentive.

It will be appreciated that rules may be used that have a temporal aspect, for example time-based or limited-time offers or specials, such as pricing rules that may only be applied on certain days or during certain time periods or windows, or offers that may have a predetermined or configurable expiration, or optionally a combination of time and other rule, parameter, or metric-based conditions, such as a rule “if player has made more than 3 purchases within the last 24 hours, offer a 3-day discount of 10%” (for example).

### Selling “Currency Combo Packs”

Once a company or game decides to support two currencies, they then quickly evolve to something like: currency 1 is used to purchase one set of goods; currency 2 is used to purchase a separate set of goods; and some goods require both currencies.

This then leads to the use case of buying a bundle of currency. Generally speaking, these games have 4 or 5 single currency offers per currency and 1-3 “combo packs” which are almost always placed at the top (or left) of the payment wall and which sell multiple currencies in a single shot.

### Selling an Item

There are a number of commonly sold items that may be supported via wizards. The typical use cases are for loyalty currency doublers and advertising removers, but it should be appreciated that a wide variety of uses may be possible according to the invention, and those described are merely exemplary.

### Using Schedules to Generate Sets of Related Payment Walls

Instead of creating payment wall directly, do in two steps. Step 1—build a price schedule: list of 8 price tags built using a hardwired price discounter and a hardwired currency multiplier. Step 2—build a wall: choose a subset of the price tags; start with 8 predefined walls (based on pulling tags); and then create payment wall groups named for schedule. It is then easy to create a new schedule and a new set of associated walls, and easier to understand how things fit together. The payment wall comes from the schedule; indexes of price tags picked; total discount or bonus relative to lowest priced item in schedule; note that discounts and bonuses are separate things. A schedule may start with price of lowest cost slot, or amount of currency for lowest cost slot. Then optional price discounts (hardwired as separate list) or currency multipliers (hardwired as separate list) may be applied as needed. Automated scheduling leads to recommendations.

### Global Specials

Suppose there are currently 4 active payment schedules, and a “global” (for everyone) special is needed. For example, in the following exemplary code sample:

(if July 2 or 3): [special offer that's fourth of July and which sits on top of the standard offers]

For this use, a new type of price tag, called a “special”, that is able to sell combo packs and items, and which exists outside of payment walls, may be used.

### Multi-Currency Prices

An app may utilize multiple currencies, for example in an app using 5 currencies: it has 1 paid currency (“diamonds”, which are also gifted in very small amounts on a daily basis and which are awarded when quests are achieved); it has a loyalty currency, “gold”; and it has multiple resource currencies: “wood”, “stone”, and “iron”. Most purchases are one of: trading diamonds for time; trading gold for soldiers; trading gold for skills upgrades; or trading gold+multiple resource currencies for buildings or building upgrades.

### Name Lists

In addition to the use of currency packs, the concept of a “name list” may be utilized by a pricing engine 501 to identify products or services. These may also comprise “container names” to identify purchasable packages or combos, optionally making the item names more “player-accessible” using friendly names. For example, rather than “100 coins”, a 100-coin bundle (for an in-game currency) may be presented as “handful of coins”, with progressively larger names for increasing bundle amounts such as “wallet of coins” (200 coin bundle, for example), “backpack of coins” (400 coins), “crate of coins” (800 coins), and such.

A further utility as envisioned by the inventor in a preferred arrangement, may be the use of rules that govern other rules (or other parameters), such as for example a rule that when enabled may restore default values or behaviors (to ease configuration rather than restoring default values individually), or a rule that substitutes or swap rules or schedules for one another (such as “move all current promotions weekend-only”, or “switch prices for these two regions”, for example), or rules that change a sort order or other classification or organization. In this manner, it may be appreciated that rule may be used not only to directly modify values or parameters, but also to more broadly modify the operation in a more global or large-scale way, facilitating rapid configuration of many elements or behaviors with maximum efficiency.

An additional utility may be the use of stochastic rules, that may take effect or modify behaviors or parameter values based on conditions or probabilities, for example there may be a rule “if player makes a purchase, there is X probability that this payment rule is applied to them”, such that when a condition is met, a rule is applied according to probabilistic conditions, rather than a simple binary “if-then” that always applies it. Such an approach may be used to provide probability-based rewards systems (such as have been shown to be effective in various studies and across various fields and disciplines), and will also help to discourage people from “training” on sales, a behavior commonly seen when users may attempt to “wait for it to go on sale”. By introducing an element of probability, it becomes more difficult to “game the system”, and encourages more normal behavior and therefore more useful data collection and analysis results, such as by reducing data bias due to modified user behavior.

### Admin App

A pricing rule admin tool and reporting functionality may be provided via a web app. It should be a highly performant, zippy, and well-designed web app. But there's no requirement for highly interactive charts, tableau style drilldowns, extensive drag-and-drop, or anything like that. A nice solid well designed web app is more than good enough.

Whenever anyone makes a change to any rule related object, need to record their action. This is modeled below by having “audit trail objects” associated to the core data structures in the following way: the object has a reference to an audit trail; an audit trail is essentially an ordered list of audit notes; audit notes are generated by the system automatically when changes happen; they can also be added by people; and they cannot be edited or deleted once saved. There is a UI to show the sequence of audit notes (UI component associated to audit trail).

### SSL Only/Focus on Security

It is desirable to be highly secure. Nothing in a web app should typically be visible without logging in, and using SSL. The exception is reports. The goal of reporting is to be embeddable in other dashboards. So there may be adoption of some form of highly authenticated signing which will return just the image when/embedded is in the URL). Longer term tablet support may be desirable as well for some functionality (in particular, alerting functionality needs to be ubiquitous).

It should be entirely possible to shut down the web app and reporting tool, and delete the web app database, without impacting production. If EC2™ goes down, obviously, everything will go down. But, short of that, failures should be entirely separated.

### The Structure of the Application

The previous section was mainly about core architectural decisions. What the admin and reporting tool will be built out of, and how it will fit into the overall architecture. This section is more about “high level principles than should inform the UX of the tool.”

In some embodiments, one may blend the reporting application and the admin tool into one UI. There are pragmatic reasons for this (they share a database, the same people use both, it simplifies deployments and makes it easier to have a uniform sense of style, etc.), but there's also one primary reason: people should be able to act on data. In a preferred embodiment, a user interface application may have central loops such as the following: the user views the main cohort report (comparative across all cohorts, current day); the user clicks a button to remove all high-performance cohorts; the user zooms in on a single cohort and chooses to view it compared to itself over the past two months at 7 day intervals (trying to see when the problem occurred); the user sees some automatic suggestions for things to do or explore; and the user takes action, probably by clicking on a button and going through a wizard.

This is not possible in a classic “reporting tool” that separates data into its own silo. That said, the application has to be somewhat modal. Three main use modes can be distinguished: “Super User”—this is an internal user, who is doing initial setup (such as deployment of the app, adding first users, possibly adding some game metadata, or viewing audit trails); new game or app configuration—there are a substantial number of questions that need to be answered and a substantial amount of configuration information to be entered before an app can go live (might distinguish the “pre-production” mode in several ways, such as for example receipt validation is automatic, reporting data is sandboxed so that once “live” is set, the pre-launch and test data doesn't contaminate production, configuration tabs have dramatic highlighting for incomplete information or information that needs validation, or there may be an overall initial configuration wizard); and “In Production”—once the game is “live’ (which really means: there are people, not in the game company, downloading the app from an app store somewhere).

Going “live” may be an explicit decision: have they entered all the data that's needed; have they generated the pricing rules from the game and business metadata information; scrubbing the reporting database; starting automated backups of production data; making sure that some users are marked as “QA users” (if they test in production, don't want that data in reports); turning on the real time dashboarding; sending an email to an internal email address (it's an important moment for billing and monitoring); configuring the ecosystem storefronts; or any other things to be done.

The UI may, in a preferred arrangement as envisioned by the inventor, say “you aren't live yet” (or similar clear indication) on every page, if you're not live.

The decision to generate a new set of pricing rules involves editing all the old rules and cohort definitions to “term limit them” (so that new users get the new pricing rules and old users get the old ones) may include the notion of an automatically generated to-do list that reflects what needs to be done to go live, or what's currently pending.

In some embodiments, one may also incorporate A/B testing and longitudinally oriented A/B testing. An A/B test is, essentially: a cohort definition; a maximum number of testers; a set of applicable pricing policies (some of which may be drawn from the general pool and some of which may be test specific—a policy can be marked as “belonging” to a test); percentile allocations for the pricing policies tc . . . ; and custom reports on the outcomes of the tests.

Similar to A/B tests, diagnostics is a special place in the admin tool where there may be alerts that may require action (these alerts might also be emailed or pushed). The major categories of diagnostics may include: time based hinting—“you've been live for a month, time to check whether the configured expectations are validated by the data”; call trending, surges and dips in activity; cohorts that are significantly underperforming with regard to ARPDAU or conversion; or empty cohorts and unused monetary policies.

It should be appreciated that in an exemplary report, a value may be seen that is both statistically significant and bad. For example: the cohorting performance metric “time until 90% inactive” (which measures the time until have the cohort churns out). Again, stressing the complete absence of any notion of visual design—this is intended to just illustrate the general idea.

There are two things to note. First, the cell may be highlighted or otherwise visually indicated because this is a statistically significant difference from the definitional cohort (the first column, in this case the population). Should distinguish the following: better than definitional cohort and the test cohort is an important one; better than definitional cohort and the test cohort isn't important one; ordinary; worse than definitional cohort and the test cohort isn't important one; or worse than definitional cohort and the test cohort is important one (where, again, better and worse are statistically significant).

Second, there's an idea that it's a visual cue that there should be things a user can do here. So when a user clicks on the icon, immediately start the “take action” flow.

A prompting system might suggest examining whether these users are behaving differently with respect to their interactions with the virtual currency system and with purchases. If they are using currency less, or carrying a low virtual currency balance, then optionally either consider testing a larger initial grant of virtual currency, or consider testing a targeted sale to users in this cohort who are more than 60 minutes in and haven't purchased. If the user chooses an option, go to a wizard to execute it.

### The Configurator

### Perform a Simple Price Test

The invention may support a simple form of testing, which involves defining, copying and tweaking a pricing rule. In order to do this, one may make a deep copy of a cohort, and the pricing components, and then reassemble the new rule. That is, the sequence is:

1. Deep copy the pricing rule

2. Edit the cohort definition (narrow it usually)

3. Edit the pricing components
a. Usually editing the base payment wall to charge different prices

4. Set restrictions
a. Percentile
b. Max Members

5. Make the rule high priority

6. Push to production

### Price Rule Wizards

These are easy to think through and involve, essentially, switching on behavior for default cohorts. As an example, simple currency bonuses may use a generic wizard to grant paid currency or to bonus with loyalty currency. Sales wizards may create a happy hour, a temporary sale, or a time limited recurring sale.

Regarding selection of a cohort, one may (for example) choose a previously defined “testing” cohort, or create a new, limited range, cohort.

Personalized incentives may include (but are not limited to): create a first purchase incentive; create a declining engagement incentive; create a “pay-to-stay” incentive; create a “pay-to-switch” incentive; inducements for users with sustained low balances; lack of progress bonus (playing, not progressing, no spend); sustained low wallet bonus; pay to switch; pay to stay; installed substitutes and declining engagement bonus; overdue to spend and declining engagement bonus; overdue to spend and lack of progress bonus; gender and age based price incentives and interdictions; separate prices for ANDROID™ or IOS™; encourage binge purchasing; or charge potential “whales” more.

Again, regarding selection of a cohort, one may (for example) choose a previously defined “testing” cohort, or create a new, limited range, cohort.

Personalized Price Increases may: move users who have had frequent purchases to a more expensive wall; remove incentives from user who has a sustained high wallet balance; or increasing engagement and lack of mindshare for competitors interdiction (might require another cohort—plays competitors).

Charging More, Or Less, Via Segmenting: charge men/women less/more; charge age bracket less/more; charge more if lots of apps installed; charge less if lots of paid games installed; or encourage “binge” purchasing for (gender, age).

Item-based bonuses: canonical item—coin doubler item; canonical item—no advertisements item; or in-game item, in general. It will generally also be possible to create the item in-flow.

### (Edit Existing Pricing Rules) Price Rule Wizards

### Single Pricing Rule Narrow/Expand

These might be simple UI actions on a pricing rule. But they do involve the creation of a new cohort to narrow or expand a pricing rule. In both cases: make a deep copy of one or more of the underlying cohort definitions; enable editing of the copies; recreate the rule; and push to production.

Single pricing rule change inducement may increase, decrease or change slots for bonuses.

Global on pricing rules may pull prices from a test into main production. This is really about taking a test rule and making it more general.

### Cohort Wizards

Cohort creation: create a new cohort by taking canned cohorts and intersecting them—this will be mainly for reporting purposes, and probably wind up being >25% of the use cases; create a new cohort using an existing cohort as a model (the “narrow or expand” model)—this will be for reporting, and also for testing/making rules more general, and will wind up being 50% of the creation; create a new cohort from scratch; or as a special case, create a cohort defined using just tags and creation date.

There may also be a general “retire cohorts” flow—over time the customers will accumulate cohort “cruft”. The clues that a cohort is eligible for retirement include: very few people in it (under 1%, for example); mostly identical to another cohort—there are two main cases here, “you've got two cohorts that have greater that 80% overlap” and “cohort A is a subset of Cohort B, has similar performance characteristics, and is more than half of it”; it contains more than half the active population; it isn't explicitly listed as a reporting cohort and yet there are no pricing rules referencing it; or all the pricing rules referencing it have been retired.

Payment Wall Wizards may: build a new payment wall from scratch; build a new payment wall, starting with another payment wall as a reference object; bump a payment wall up (ask for percent); bump a payment wall down (ask for percent); raise all prices (all payment walls); lower all prices (all payment walls); add an item to a set of payment walls; “copy and tweak”; or “copy, tweak and replace”. Publishing Wizards may go live for the first time, or push current edits live.

### DETAILED DESCRIPTION OF EXEMPLARY EMBODIMENTS

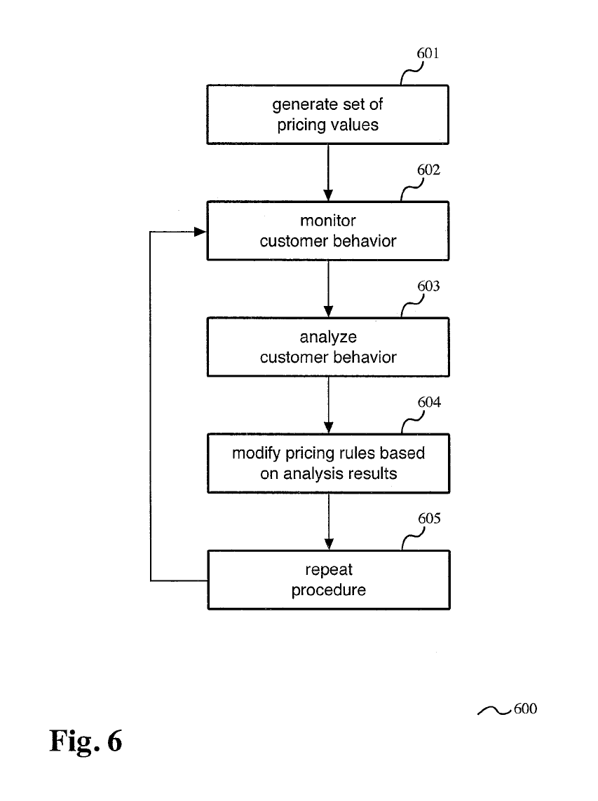

FIG. 6 is a method flow diagram illustrating an exemplary method 600 for generating and modifying pricing rules, according to a preferred embodiment of the invention. In an initial step 601, a pricing engine may generate a set of pricing rules. In a next step 602, customer behavior may be monitored or recorded, such as by a customer segmentation server, for example to identify behavior patterns or key data that may be considered relevant to pricing operations (such as customer response to price changes, for example). In a next step 603, collected behavior data may be analyzed, such as to determine trends or patterns or to identify additional data that may not be initially available through simple collection alone. In a final step 604, the behavior data or analysis results may be used to modify pricing rules, for example to update rules to optimize customer behavior based on identified response patterns or preferences. In this manner, customer behavior may be used to drive rules-based pricing updates in an automated or semi-automated fashion. In an optional iterative step 605, operation may continue in an iterative loop from a previous step 602, facilitating a continuous automated or semi-automated operation.

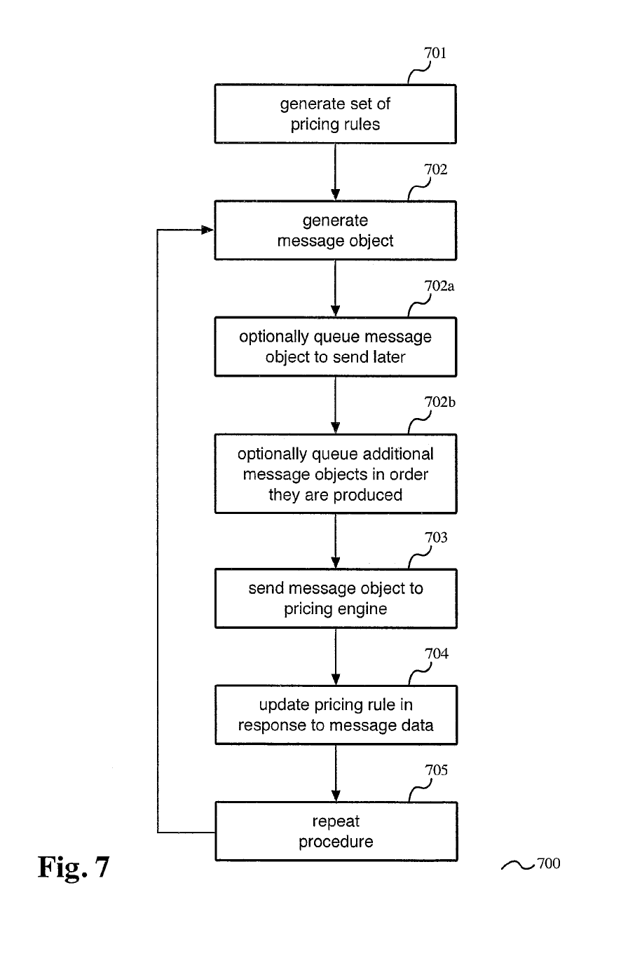

FIG. 7 is a method flow diagram illustrating an exemplary method 700 for message-based pricing modification, according to a preferred embodiment of the invention. In an initial step 701, a pricing engine may generate a set of pricing rules. In a next step 702, a pricing message client or server may generate a message object suitable for interpretation or use by other system components, for example containing instructions for a pricing update to be used by a pricing engine. In an optional substep 702a, message objects may be queued for later sending (such as may be desirable when a connection to other system components is lost), and in a further substep 702b they may be queued in the order they are produced, such as to preserve the ordering of events when they are later sent.

In a next step 703, message objects may be sent to a pricing engine, such as via a message server or a direct connection via a digital packet network such as the Internet or other suitable communication network. In a final step 704, the pricing engine may update pricing rules in response to the message object, such as (for example) updating a particular rule according to instructions contained within the message data. In an optional iteration step 705, operation may continue in an iterative loop from a previous step 702, facilitating a continuous automated or semi-automated operation.

Predictive Messaging may utilize a message queue instead of an API. Instead of making an API call over the wire, a message object is inserted into a message queue, for example comprising an API call, predicted outcome, or error handler. Calls go to server in background (no client side delays), and, as long as the prediction was accurate, everything is fine—if prediction isn't accurate, error handler is called on return. This enables the app to continue using SDK without network pauses and when device is offline.

### Sales and Messaging

An exemplary operation flow may generally consist of asynchronous data collection, and when the user signals to the app, somehow, that they want to see the payment wall, the relevant price set is determined and returned by the server. This works well, as long as there is no messaging. If, on the other hand, the app has a button that launches the payment wall, and the button has some specialized text (for example, informing the user of a sale), then it becomes very problematic. Unless the user is informed of the sale, the power of the sale is somewhat minimized. If the user is informed of a sale via button text, then the system should know about the sale. Which means there must be a set of offers in mind at that point. And, until the button text changes, some sort of sale should be present on the payment wall. Similarly, if the user is informed, via a push notification, that there is a sale, then there is now an obligation to honor that sale for some time frame. If it becomes a problem that people are scamming the system by hacking the application

How does Stickiness Really Work

The core idea behind stickiness is different levels of stickiness: the baseline prices have stickiness, and each of the adjustments have stickiness. Stickiness is really two things: time based redemption limits, and the minimal time to honor the offer.

Time-based redemption limits: usually baseline prices don't have these, but usually adjustments do; they may appear as “number of times this user can redeem this price”, or “timeframe for redemption limitations to be in effect”, and may generally include a minimum time to honor the price set.

The timeframe itself is a triplet, with an absolute limit (when the offer is no longer valid for this user as a function of absolute time) as a timestamp, and a relative limit (when the offer is no longer valid for this user as a function of the user's point in their lifecycle) as one of a small number of pre-eumerated types. Usually both of these are filled out.

### How do Sales and Messaging Really Work

In an example app, the game fires up and it asks “what text goes on the button?”, which is an API call. To do this: get a set of prices; store the prices locally with some sort of globally unique id (which is generated on the server side); and return the appropriate button text.

There are now two issues: as long as the button is displaying that text, need to honor the sale prices; and need to have a way to get new text for the button in the background.

The right solutions may be: the call when the user clicks the button, that gets the price points, carries the unique id; or in the background, occasionally call the server to get prices. This way, the next time the client asks for the button text, have an up to date answer. Ideally, this may also implement a local (in the client) callback interface so that the game or app can get a callback when the button text should change.

It should be appreciated that these are the “right solutions”, because: they enable honoring a sale, while still not starting a stickiness clock (start the relative clock, for example, when the user sees the actual offers, and the unique id will help with respect to the reporting functions); and the background thread enables updating the button text in an unobtrusive way. Sometimes, sales go away. And, sometimes, sales happen.

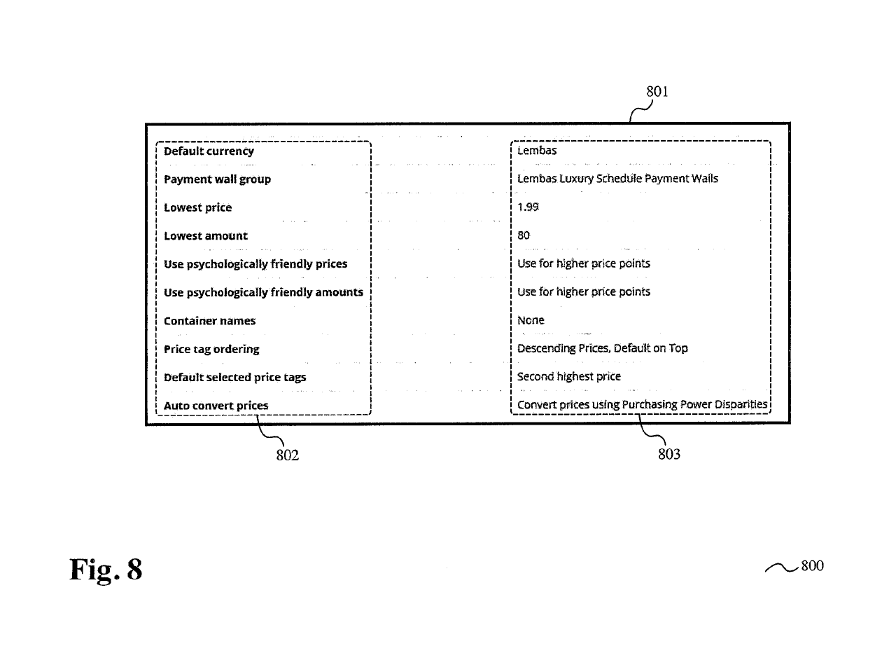

FIG. 8 is an illustration of an exemplary user interface 800 for viewing pricing rules. As illustrated, an interface 800 may comprise a price rule display 801 that may further comprise a variety of presentable information in a read-only or interactive format interchangeably, such as for review or interaction by a human user. Information displayed may comprise a plurality of price rule names or identifiers 802, or a brief description 803 such as might be assigned to summarize a rule for quick viewing.

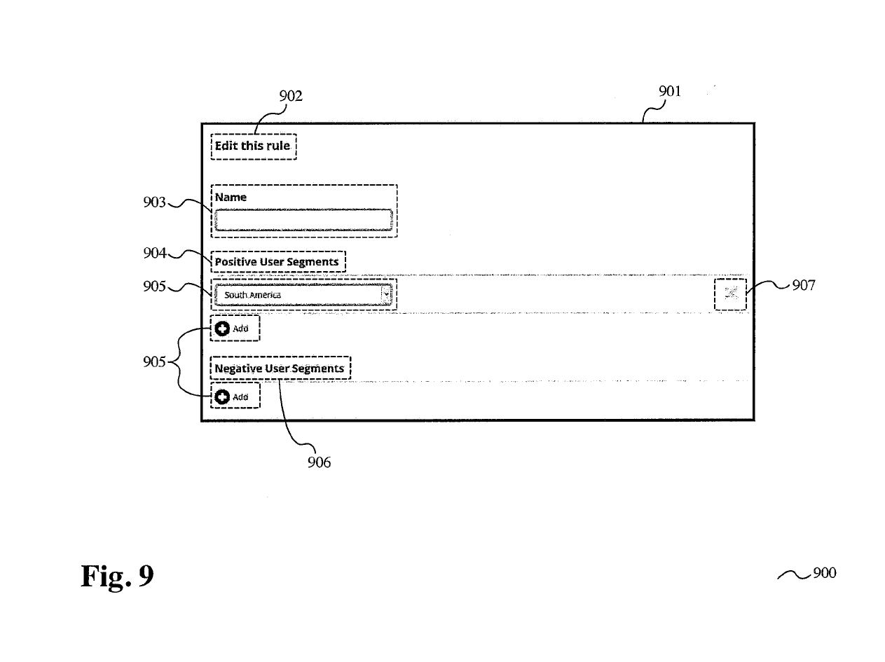

FIG. 9 is an illustration of an exemplary user interface 900 for modifying pricing rules. As illustrated, an interface 900 may comprise a price rule editor 901 that may present a variety of interaction options for a user to create, configure, or modify pricing rules, or a variety of descriptive information for review such as to identify a rule being modified (for example, a title 902 or other description). Interactive options may comprise text fields such to input a segment name 903, or fields to edit “positive user segments” 904 that may represent rules for determining what users are to be included in the segment, or “negative user segments” 906 that may represent rules for determining what users are to be excluded from a segment. For example, there may be selectable categories or drop-down lists 905 for user types or groups, or clickable or selectable buttons 905 to add new types or categories, as well as buttons or other interactive controls to remove selected types 907, as illustrated.

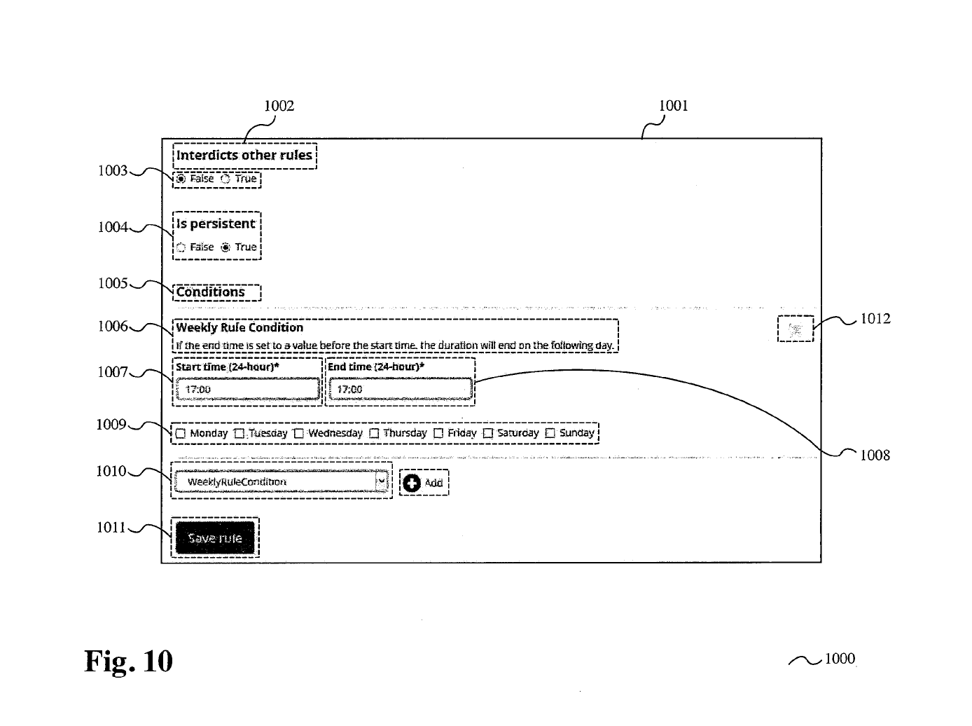

FIG. 10 is an illustration of an exemplary user interface 1000 for modifying pricing rules. As illustrated, an interface 1000 may comprise a price rule editor 1001 that may present interactive controls or read-only information for review or use by a human user, such as to setup, configure, or modify pricing rules or to review existing rule information. As illustrated, interactive options may comprise configuration rules 1002, 1004, optionally with controls 1003 for toggling or configuring their application to the selected price rule (such as applying preconfigured rules to speed up the creation of new pricing rules, for example as shown there may be a rules that control “interdiction”, “persistence”, or other qualities). There may also be rule conditions 1005, such as to control when a rule is applied to a selected user segment, for example as illustrated there may be conditions pertaining to rule timing such as rotating weekly timers 1006 to control hours every day when a rule is applied 1007, and then un-applied 1008, as well as optionally selectable controls 1009 to determine what days the times are applied, drop-down or selectable lists 1010 to select conditions or condition types, clickable or otherwise interactive buttons or controls to disable conditions 1012, as well as controls to save or submit a rule 1011 when finished configuring the options available.

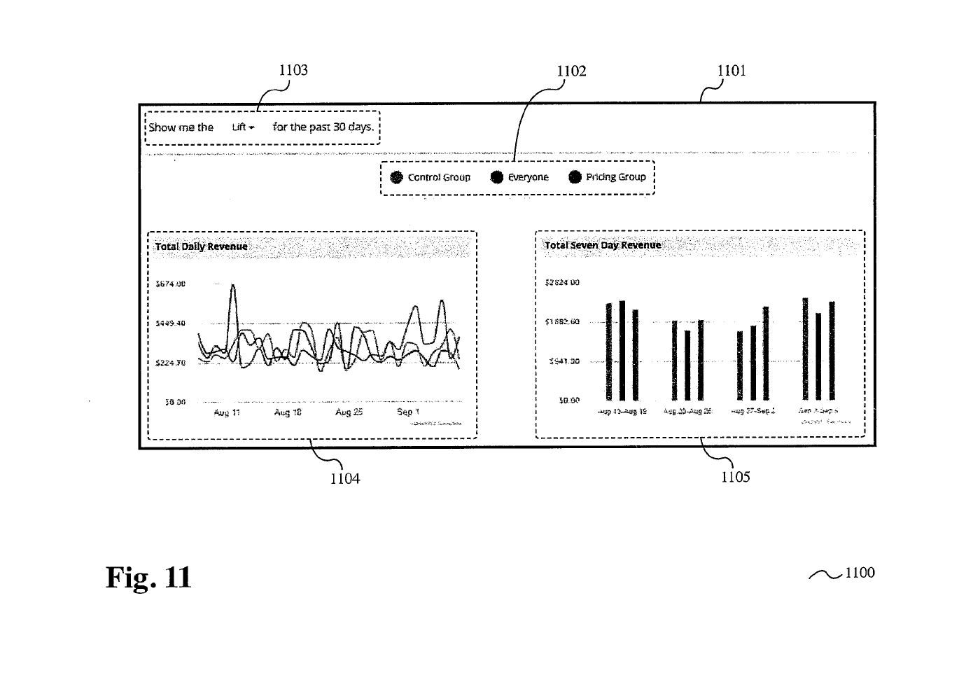

FIG. 11 is an illustration of an exemplary user interface 1100 for viewing pricing reports. As illustrated, an interface 1100 may comprise a report 1101 that comprises a variety of data from price rules or user segments, that may be presented in a read-only fashion for review or optionally with interactive controls such as a drop-down or selectable list 1103 to select what rules or segments are being reported in a current display. Reported data may comprise visual indicators such as graphs of data over time 1104 or comparative graphs 1105, as well as (as appropriate) a key 1102 to enable a user to easily understand the data being presented in the report.

In this manner, the interfaces described may be utilized in an exemplary arrangement to enable a user to setup and configure pricing rules and user segments, apply rules to segments as needed, and then to view reports of the results of operation according to the configuration information.

The skilled person will be aware of a range of possible modifications of the various embodiments described above. Accordingly, the present invention is defined by the claims and their equivalents.

What is claimed is:

1. A system for automated rules-based pricing via a dynamic pricing system that maintains pricing rules based on configurable rules, in an online digital entertainment environment, comprising:
a pricing console computer comprising program code stored in a memory and adapted to operate a web-accessible interface for receiving user interaction;
a database computer comprising program code stored in a memory and adapted to store information from the other components of the system;
a pricing engine computer comprising program code stored in a memory and adapted to generate at least a plurality of pricing rules;
a pricing analysis server computer comprising program code stored in a memory and adapted to analyze at least the price rules and provide the analysis results to the pricing console; and
a customer segmentation server computer comprising program code stored in a memory and adapted to receive customer interactions via a digital packet network and to generate customer behavior data values based at least in part on those interactions, and to provide the behavior data values to the pricing engine.

2. The system of claim 1, wherein the pricing console provides at least a plurality of pricing rules for user interaction, the pricing rules also being provided to the pricing engine.

3. The system of claim 2, wherein the pricing engine modifies the pricing rules based at least in part on the received user interactions.

4. the system of claim 1, wherein the pricing analysis server generates reports based at least in part on analyzed data values, and provides the reports to the pricing console.

5. The system of claim 4, wherein the pricing console presents the reports for review by the user, and is adapted to receive interactions form the user via the reports.

6. The system of claim 5, wherein the reports comprise at least a plurality of interactive pricing rules.

7. The system of claim 6, wherein the user interaction is provided to the pricing engine and used for modification of the pricing rules.

8. The system of claim 1, further comprising a pricing message server computer comprising program code stored in a memory and adapted to generate software-based message objects comprising at least interaction information adapted for use by other components of the system.

9. the system of claim 8, further comprising a pricing message client comprising program code stored in a memory and adapted to produce message objects, and adapted to provide the price message objects to other components of the system via a digital packet network.

10. The system of claim 9, wherein the pricing message client is installed on a user's electronic device.

11. The system of claim 9, wherein the pricing message server is adapted to receive price message objects.

12. The system of claim 9, wherein the pricing message client further comprises at least a message queue adapted to store message objects in an orderly fashion, and adapted to provide the message objects in the stored order to other components of the system.

13. A method for automated rules-based pricing, comprising the steps of:
generating, using a pricing engine computer comprising program code stored in a memory and adapted to generate at least a plurality of pricing rules, an initial set of pricing rules;
monitoring, using a customer segmentation server computer comprising program code stored in a memory and adapted to receive customer interactions via a digital packet network and to generate customer behavior data values based at least in part on those interactions, and to provide the behavior data values to the pricing engine, customer behavior data;
analyzing, using a pricing analysis server computer comprising program code stored in a memory and adapted to analyze at least the pricing rules and provide the analysis results to the pricing console, the behavior data;
providing the analysis results to the pricing engine; and
modifying the pricing rules based at least in part on the analysis results.

14. The method of claim 13, further comprising the step of repeating the method in an iterative loop.

15. A method for message-based automated pricing, comprising the steps of:
generating, using a pricing engine computer comprising program code stored in a memory and adapted to generate at least a plurality of pricing rules, an initial set of pricing rules;
generating, using a pricing message client comprising program code stored in a memory and adapted to produce price message objects, and adapted to provide the price message objects to other components of the system via a digital packet network, a plurality of price message objects;
providing the price message objects to the pricing engine via a digital packet network; and
modifying the pricing rules based at least in part on the received price message objects.

16. The method of claim 15, further comprising the step of storing the price message objects in a database computer comprising program code stored in a memory and adapted to store information from the other components of the system.

17. The method of claim 15, further comprising the step of repeating operation in an iterative loop.

18. The method of claim 15, further comprising the step of storing, using a pricing message client comprising program code stored in a memory and adapted to produce price message objects, and adapted to provide the price message objects to other components of the system via a digital packet network, a plurality of price message objects in an ordered message queue.

19. The method of claim 18, further comprising the step of providing the price message objects to the pricing engine via a digital packet network in the queued order.

20. The method of claim 19, further comprising the step of repeating operation in an iterative loop.

21. A system for ad-hoc pricing analysis via a pricing analysis system that creates samples of data and user profiles, comprising at least a pricing analysis server computer comprising program code stored in a memory and adapted to analyze pricing and user information, and adapted to compute intermediate data and produce reports based at least in part on the information analysis results.

22. The system of claim 21, wherein the pricing information comprises at least a plurality of price values.

23. The system of claim 21, wherein the pricing information comprises at least a plurality of price rules.

24. The system of claim 21, wherein the user information comprises at least a plurality of user segments.

25. The system of claim 21, wherein the analysis operation occurs continuously in an iterative loop.

26. The system of claim 25, wherein the iterative loop proceeds asynchronously.
